(19) United States
(12) Patent Application Publication
(10) Pub. No.: US 2011/0249963 A1
(43) Pub. Date: Oct. 13, 2011

(54) MOUNT DEVICE FOR STEREOSCOPIC RECORDING RIGS AND STEREOSCOPIC RECORDING DEVICE

(75) Inventors: Sebastian Cramer, Muenchen (DE); Jan Bernotat, Bergen (DE)

(73) Assignee: SCREEN PLANE GmbH, Muenchen (DE)

(21) Appl. No.: 13/082,766

(22) Filed: Apr. 8, 2011

(30) Foreign Application Priority Data
Apr. 9, 2010 (DE) 20 2010 004 747.1

(51) Int. Cl. G03B 35/08

(52) U.S. Cl. 396/325

(57) ABSTRACT

The mount device for a stereoscopic recording rig comprising two cameras (3a, 3b), each having one lens (4a, 4b) includes a mount element (2) which can be tilted at a bearing means (11a) about a horizontal tilt axis (11). Furthermore, a beam splitter (7, 8) attached at the mount element (2) at a radial distance from the tilt axis (11) and comprising a partially transparent mirror (8) is provided, the mirror plane of which extends in parallel to the tilt axis (11). Two attachment means (5a, 5b) are mounted at the mount element (2) at both sides of the beam splitter (7, 8) at an angular distance about the tilt axis, wherein one camera (3a, 3b) can be mounted at each of the attachment means (5a, 5b) such that the projections of the optical axes (6a, 6b) of the lenses of the cameras (3a, 3b) from a horizontal direction intersect on an imaginary vertical plane cut perpendicularly by the tilt axis (11) and the optical axes (6a, 6b) hit the mirror plane. The tilt axis (11) intersects with the imaginary vertical plane in an area limited by the horizontal projections of the attachment means and the beam splitter (7, 8) on the vertical plane. A mounting means (10) is provided at the bearing means (11a) at a distance from the horizontal tilt axis (11) for attachment to a pan and tilt system.

### CROSS-REFERENCE TO RELATED APPLICATION

This application claims benefit of German Utility Application 20 2010 004 747.1, filed Apr. 9, 2010, the disclosure of which is incorporated herein in its entirety by reference.

### BACKGROUND OF THE INVENTION

The invention relates to a mount device for stereoscopic recording rigs, by means of which a tilt angle of a camera mount of both recording cameras can be preset. The invention further relates to a stereoscopic recording device comprising the mount device.

Conventional mirror rigs for stereoscopic recordings usually have two recording cameras arranged at an angle of 90° and a mirror box comprising a beam splitter mirror which is arranged at an angle of 45° and deviates the beam path of the vertically oriented camera. Such an arrangement is, for example, presented in FIG. 1 of the publication US 2007/0140682 A1. Herein one or both recording cameras are horizontally laterally displaceable, so that the interaxial distance can be adjusted and also be reduced to up to 0. The advantage of such mirror rigs, as compared to a side-by-side arrangement, is that the distance of the two recording lenses is not determined by the physical width of the cameras, but can also be adjusted to be very narrow.

Conventional mirror rigs have, at their bottom side, a mounting plate, by means of which such a mirror rig can be mounted on a commercially available fuild head for performing pan and tilt movements. Vertically arranged mount elements are firmly connected to the mounting plate and support the two cameras and the mirror box. Except for a fine adjustment of one or both cameras, the mounts of the mirror box and the cameras are rigidly connected to the mounting plate.

Herein it is disadvantageous that a tilt angle is adjusted exclusively by means of a fuild head and thus the whole weight of said rigid structure is inclined about the horizontal tilt axis of the fuild head.

Since conventional fuild heads are usually built such that the tilt means is arranged vertically above a pan means, a tilt movement of the fuild head in each case brings about a large excess weight towards the front or the rear, particularly since such a mirror rig together with the cameras and the lenses can easily amount to 50 kg or more.

### SUMMARY OF THE INVENTION

The object underlying the present invention is to create a mount device and a stereoscopic recording device, by means of which a tilt angle of a stereoscopic recording rig can be preset such that a disadvantageous load displacement caused by a tilt adjustment at commercially available fuild heads can be reduced.

This object is achieved by a mount device for a stereoscopic recording rig comprising two cameras, each having one lens, the mount device comprising
a mount element which can be tilted at bearing means about a horizontal tilt axis;
a beam splitter attached to said mount element at a radial distance from said tilt axis and comprising a partially transparent mirror defining a mirror plane which extends in parallel to said tilt axis;
two attachment means mounted at said mount element at both sides of said beam splitter at an angular distance about said tilt axis, wherein one camera can be mounted at each of said attachment means such that projections of optical axes of said lenses of said cameras seen from a horizontal direction intersect on an imaginary vertical plane intersected perpendicularly by said tilt axis and said optical axes impinge on said mirror plane;
wherein said tilt axis intersects with said imaginary vertical plane in an area limited by projections seen from a horizontal direction of said attachment means and said beam splitter on said vertical plane;
wherein mounting means are provided at said bearing means at a distance from said horizontal tilt axis for attachment to a pan and tilt fuild head.

Since in the case of the mount device according to the invention the tilt axis intersects with the imaginary vertical plane in an area limited by the horizontal projections of the attachment means and the beam splitter on the vertical plane, the tilt axis is located in the proximity of or at the overall gravity center of the rotatable mount element together with the mounted cameras and the beam splitter, so that tilting is possible without exertion of force. Moreover, a tilt adjustment of the whole structure of cameras and mirror box can be predetermined, and it is also possible to rotate cameras arranged at an angle of 90° with respect to one another about the horizontal tilt axis perpendicularly to the optical axes of the two recording cameras by full 180°.

Ideally, the tilt axis is located on the overall gravity center. Since however, according to the respective application, lenses of different lengths are used at the cameras, the overall gravity center is shifted accordingly. Thus it is preferred that the tilt axis is positioned such that in all cases of application it is located at a distance of less than 10 cm, preferably less than 3 cm, from the overall gravity center.

Due to this fact different tilt angles can be predetermined without any considerable change in the loading condition. Likewise it is possible to rotate the beam splitter with the mirror box completely to the top and thus to create an exit of the optical axes which is located at a significantly greater height, which can be advantageous for certain image compositions, for example, in cases where the camera is to travel through scarcely below a subject.

In another aspect of the invention a stereoscopic recording device comprises a mount device of the present invention, one camera with lens being mounted at each of the attachment means.

### BRIEF DESCRIPTION OF THE DRAWINGS

Hereinafter an exemplary embodiment of the invention will be explained in greater detail by way of drawings, wherein

FIG. 1 shows a side view of an initial position of a stereoscopic recording unit comprising two recording cameras attached at an L-shaped mount element, which in its vertex is connected to a mirror box and at both sides is supported by an arc-shaped mount bracket, wherein the concave area of the mount bracket is directed towards the front;

FIG. 2 shows a rear view of the stereoscopic recording unit of FIG. 1;

FIG. 3 shows a schematic side representation of the recording unit of FIG. 1, wherein a mount element is tilted with respect to the initial position somewhat towards the front about a tilt axis;

FIG. 4 shows a schematic side representation of the recording unit of FIG. 1, wherein the mount element is tilted with respect to the initial position somewhat towards the rear about a tilt axis;

FIG. 5 shows a schematic side representation of the recording unit of FIG. 1, wherein the mount element is tilted with respect to the initial position by 180° towards the rear about a tilt axis;

FIG. 6 shows a schematic side representation of the recording unit of FIG. 1, wherein the mount element is tilted with respect to the initial position by 180° towards the rear about a tilt axis, wherein the mount bracket is arranged such that the concave area is directed towards the rear.

### DETAILED DESCRIPTION

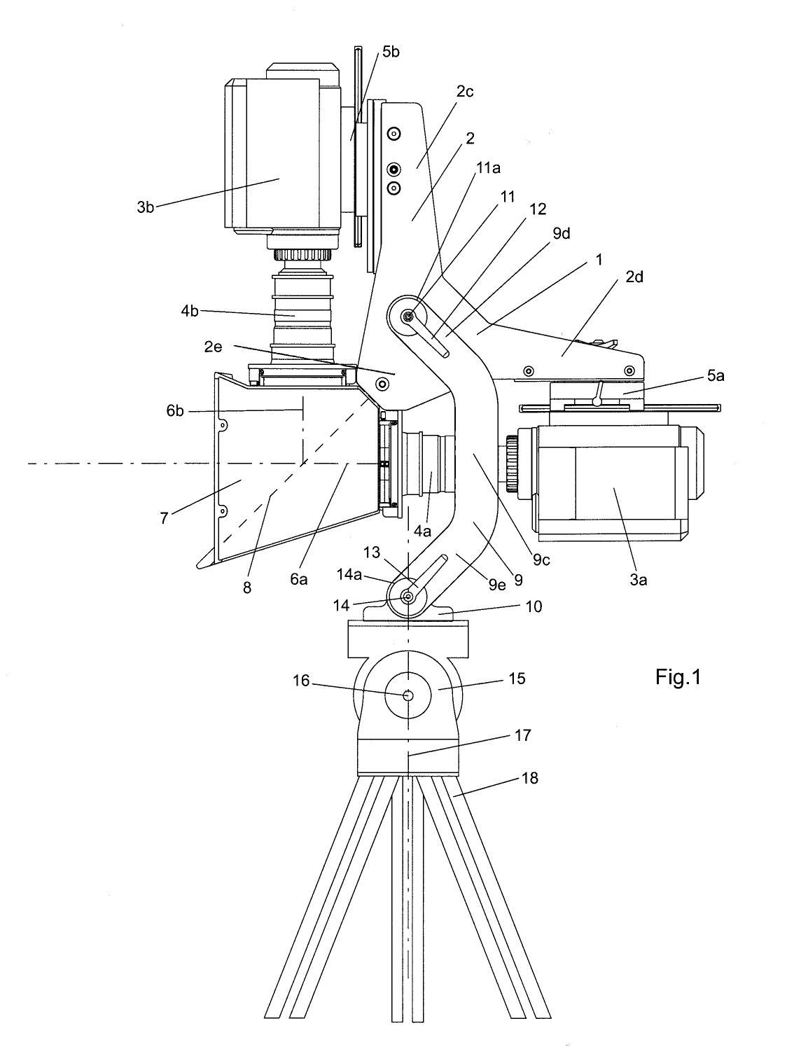

FIGS. 1 to 6 show a stereoscopic recording unit 1 comprising a mount element 2 having essentially an L-shape as seen from the side, which is formed by two L-shaped side plates 2a, 2b arranged at a horizontal distance from one another and forms a stable structural unit due to stiffened portions and screw joints not shown in detail. Instead of a plate structure, use can also be made, for example, of structures made of tubes or one-piece structural elements made of fiber composites.

Each of two recording cameras 3a, 3b oriented at an angle of 90° with respect to one another is attached to the mount element 2 at a respective leg 2c, 2d of the mount element 2 at camera attachments 5a, 5b, wherein each of the recording cameras 3a, 3b has a lens 4a, 4b.

The cameras 3a, 3b are oriented such that the projections of their optical axes 6a, 6b seen from a horizontal direction intersect on the specular surface of a partially transparent beam splitter mirror 8, wherein the beam splitter mirror 8 is arranged at an angle of 45° with respect to the optical axes and is located in a mirror box 7. In other words, the optical axes 6a, 6b in the representation of FIG. 1 intersect on the mirror surface although the axes 6a, 6b are offset with respect to one another perpendicularly to the sheet plane of FIG. 1.

The mirror box 7 is firmly fixed to the outside of the vertex 2e of the L-shaped mount element 2.

Advantageously, such a connection is realized detachably in a screwed or clamped manner and determined by alignment pins and/or precise stoppers, not shown in detail, so that a precise orientation of the mirror box 7 and thus also the beam splitter mirror 8 is guaranteed. A detachable connection enables the mechanical separation of the mirror box 7 and the remaining unit, which makes it possible, for example, to transport the individual components in a space-saving manner.

Each of the recording cameras 3a, 3b is connected to the mount element 2 by means of the camera attachments 5a, 5b. Usually such camera attachments 5a, 5b are provided with so-called bridge plates oriented in parallel to the optical axis 6a, 6b of the respective camera 3a, 3b. For example, lenses of different physical lengths can be used by means of such bridge plates, since the cameras 3a, 3b can be displaced and locked at their distance from the mirror box 7.

In most cases, such camera attachments 5a, 5b also have a fine adjustment, by means of which the optical axis can be displaced perpendicularly to its orientation. Other common fine adjustments are done by a rotation about the optical axis and a fine adjustment for the inclination of the optical axis. Herein such a fine adjustment can be provided either for a camera or for both cameras. Fine adjustments of this kind for mirror rigs are state of the art and will not be explained herein in greater detail. Often the mirrors themselves, too, can be finely tilted and adjusted about a horizontal axis, which essentially extends through the mirror center, and partially replace other fine adjustment possibilities. Likewise variants are known, wherein the mirror can be displaced and fixed towards the direction of the optical axes of the recording cameras.

The fine adjustments provided in or at the camera attachments 5a, 5b can be used to superimpose the optical axes of both cameras in registry with one another, and to correct mechanical inaccuracies in the recording unit itself, in the cameras 3a, 3b and their lens mounts or in the lenses 4a, 4b used.

In the area of the vertex 2e, i.e. in an area limited by the beam splitter mirror 8 and the two camera attachments 5a, 5b, the L-shaped mount element 2 is hinged at both sides at an upper end of each of the arc-shaped mount brackets 9a, 9b such that it can be tilted about a horizontally located tilt axis 11 at a bearing means 11a, wherein the tilt axis 11 extends in parallel to the plane of the beam splitter mirror 8. Each of the mount brackets 9a, 9b thus forms one support element of a support means. A preset tilt angle between the arc-shaped mount brackets 9 and the L-shaped mount element 2 can be fixed by means of a clamping lever 12. Advantageously, such a rotatable bearing is realized by engaging locking disks or rosettes, since these guarantee especially secure clamping and locking.

Each of the arc-shaped mount brackets 9a, 9b has two legs 9d, 9e starting from a straight middle section 9c and bent at an obtuse angle. The concave area of the arc-shaped mount brackets 9a, 9b is designed such that it is directed towards the recording direction of the stereoscopic recording unit 1, i.e. towards the mirror box 7. The mount brackets 9a, 9b are formed mirror-symmetrically with respect to a vertical plane which extends in the middle between the side plates 2a, 2b in parallel thereto and is cut perpendicularly by the horizontal tilt axis 11.

Such a design is advantageous since the arc-shaped embodiment of the arc-shaped mount brackets 9a, 9b partially encloses the mirror box 7, when tilting down the L-shaped mount element 2.

The horizontal tilt axis 11 about which the L-shaped mount element 2 can be tilted at bearing means 11a with respect to the arc-shaped mount brackets 9a, 9b advantageously runs as closely as possible through the gravity center of the unit of the L-shaped mount element 2, the cameras 3a, 3b and the mirror box 7. Since different cameras 3a, 3b can be attached to the unit as well as lenses of different lengths and weight 4a, 4b are used, such a determination of the gravity center can only be done approximately.

The arc-shaped mount brackets 9a, 9b are at the lower leg 9e connected in a hinged manner to a mounting plate 10 such that they can be tilted about a horizontal tilt axis 14 extending in parallel to the tilt axis 11. A preset angle can be locked by means of a clamping lever 13. Herein it is also advantageous to realize such a bearing with engaging locking disks in order to guarantee secure locking, and to restrict the tilting range, for example, through locking pins in order to prevent the unit from being inclined too much towards the front or the rear.

The adjustment range can be increased by means of this second possible way of adjusting a tilt angle.

The mounting plate 10 is mounted at a commercially available fuild head 15, which can perform tilt movements about a horizontal axis 16. Likewise such a fuild head 15 can perform pan movements about a vertical axis 17 through its center. Usually such commercially available fuild heads are provided in both axes with a dampening means enabling smooth tilt and pan movements.

Such a commercially available fuild head is mounted on a tripod 18, but can likewise by attached at a dolly, an adapter, a pin or the like.

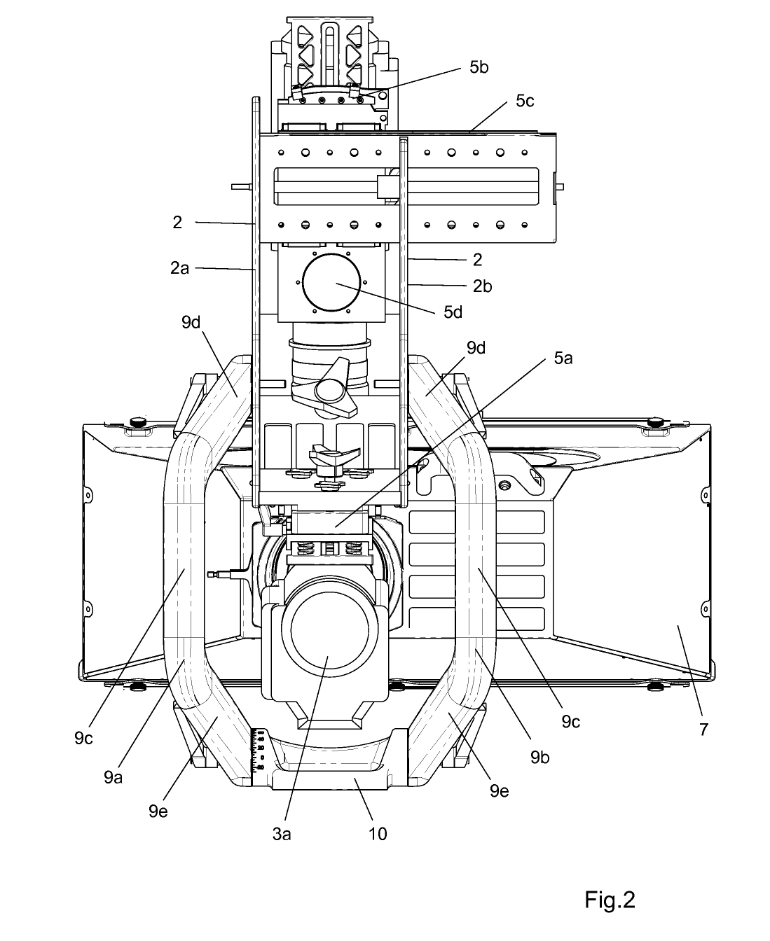

FIG. 2 shows a rear view of the stereoscopic recording unit.

Usually in the case of mirror rigs one or both cameras can be displaced in the horizontal direction, perpendicularly to the optical axes of both cameras. The camera mount 5b shown here has a displacement unit 5c for adjusting the interaxial distance.

Such a displacement unit 5c usually consists of a linear guide and a carriage carrying the actual camera mount 5b. An adjustment of the interaxial distance can be realized either manually or in a motor-driven manner by means of a spindle or a toothed belt or similar structural elements.

In the case of the exemplary embodiment shown it is advantageous that the upper camera 3b is used for adjusting the interaxial distance, since due to this fact the L-shaped mount element 2 can be realized in a very narrow design. However, it is also common to realize designs where only the horizontally oriented camera or both cameras are displaced with respect to one another.

Often stereoscopic recording units also have a tilt axis at one or both cameras, which extends perpendicularly to the respective optical axis and by means of which a mechanical convergence can be adjusted.

In the exemplary embodiment, such a tilt axis is provided by the pivot bearing 5d and enables a swiveling movement by up to 5 degrees by means of a motor not shown in detail.

The arc-shaped mount brackets 9a and 9b are attached at both sides of the L-shaped mount element 2 and additionally have an outwardly directed arc-shaped design, as can be seen in FIG. 2. Starting from the vertically extending middle section 9c, the short legs 9d, 9e converge in an obtuse angle to the L-shaped mount element 2 and to the mounting plate 10, respectively. Such an arc-shaped design is advantageous, since it guarantees better accessibility of the camera 3a, 3b and the lenses 4a, 4b.

FIG. 3 shows a down tilted camera configuration, wherein the L-shaped mount element 2 has been tilted downwardly at the upper end of the arc-shaped mount brackets 9a, 9b about the horizontal axis 11 and has been locked by means of a clamping lever 12. Herein the arc-shaped mount brackets 9a, 9b accommodate the shape of the mirror box 7.

The arc-shaped mount brackets 9 are at their bottom side also slightly tilted about the horizontal axis 14 towards the front with respect to the mounting plate 10 and locked by means of the locking lever 13. Due to this additional inclination the overall angle of viewing direction is increased to nearly 45° without bringing the system much out of its gravity center.

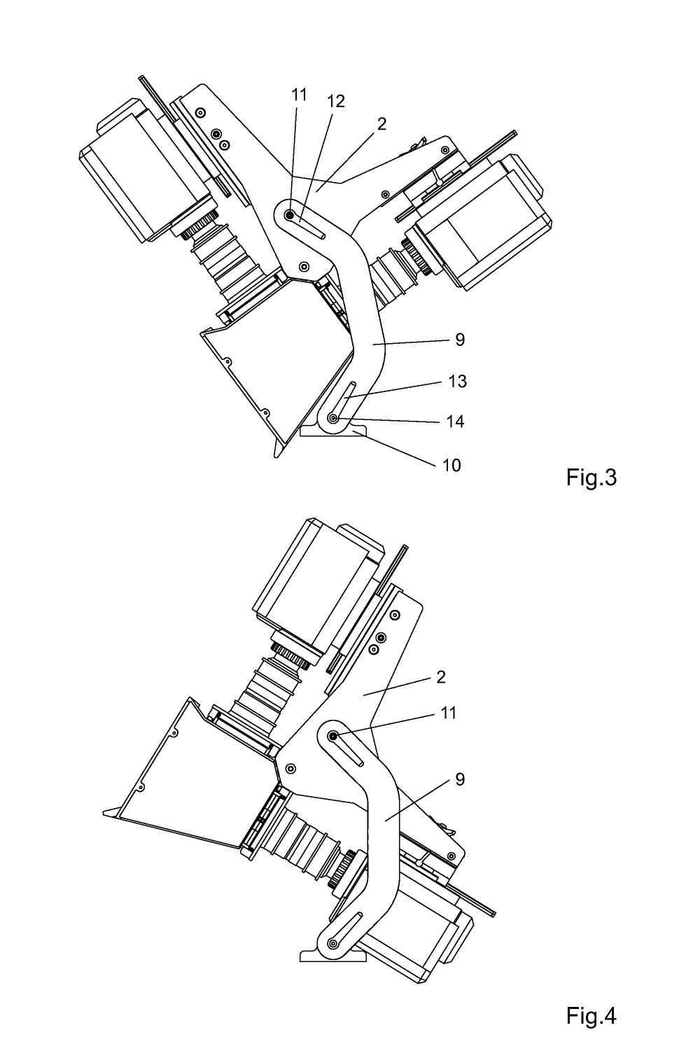

FIG. 4 shows a stereoscopic recording unit tilted upwardly about the horizontal axis 11 and locked, wherein the middle section of the arc-shaped mount brackets 9a, 9b is vertically oriented. In this case, too, the overall system is largely in balance.

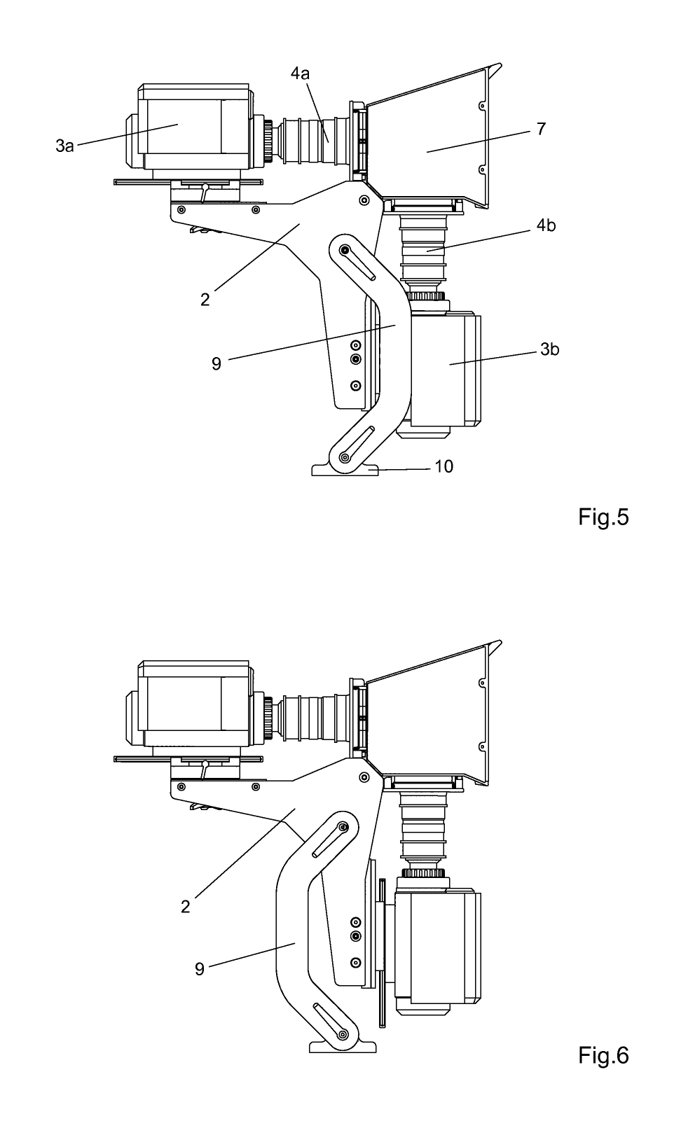

FIG. 5 shows an L-shaped mount element 2 tilted by full 180°. Depending on the length of the recording cameras 3a, 3b and its lenses 4a, 4b, it can be necessary to take one of the cameras off for a short time in order to achieve such a configuration. In this case, too, the system is largely in balance.

The camera 3a, which in its normal position is horizontally oriented, is now directed in the opposite direction, the camera 3b, which has previously been directed vertically downwardly, is now directed upwardly. Due to this fact the mirror box 7 is now located at a considerably greater height than it is the case in FIG. 1. This can have a positive effect with regard to image composition, for example, in cases where the camera is to travel through scarcely below a subject, since the exit of the optical axes is considerably nearer to the upper edge of the overall system.

A further application of such a configuration is, for example, the use on a camera crane where the mounting plate 10 is not attached standing on a tripod, but suspended from a crane. In the case of such an application, the overall system would therefore have the same orientation as shown in FIG. 1, however in the form of a suspended configuration.

The orientation shown in FIG. 6 is identical to the one shown in FIG. 5; however, in this case the arc-shaped mount brackets 9a, 9b have an orientation in the viewing direction of the overall system. This guarantees better accessibility of the cameras. In this case the concave area accommodates the displacement unit 5c, not shown here, for adjusting the interaxial distance.

Advantageously, the arc-shaped mount brackets 9a, 9b are designed to be mirror-symmetric with respect to a radial plane through their center. This makes it possible to unscrew them and to install them again in a position rotated by 180° about their longitudinal axis, wherein the concave area in this case is directed towards the opposite direction. Such an inverted installation enables a configuration as shown in FIG. 6.

1. A mount device for a stereoscopic recording rig comprising two cameras, each having one lens, the mount device comprising
a mount element which can be tilted at bearing means about a horizontal tilt axis;
a beam splitter attached to said mount element at a radial distance from said tilt axis and comprising a partially transparent mirror defining a mirror plane which extends in parallel to said tilt axis;
two attachment means mounted at said mount element at both sides of said beam splitter at an angular distance about said tilt axis, wherein one camera can be mounted at each of said attachment means such that projections of optical axes of said lenses of said cameras seen from a horizontal direction intersect on an imaginary vertical plane intersected perpendicularly by said tilt axis and said optical axes impinge on said mirror plane;
wherein said tilt axis intersects with said imaginary vertical plane in an area limited by projections seen from a horizontal direction of said attachment means and said beam splitter on said vertical plane;
wherein mounting means are provided at said bearing means at a distance from said horizontal tilt axis for attachment to a pan and tilt fuild head.

2. The mount device according to claim 1, wherein said tilt axis is arranged such that it extends through an overall gravity center, projected in a horizontal projection on said vertical plane, of said cameras to be mounted and said beam splitter and said mount element or in the proximity of said overall gravity center.

3. The mount device according to claim 1, wherein said mount element is substantially L-shaped with a vertex from which two legs extend perpendicularly with respect to one another, wherein said attachment means are mounted an said legs radially outside with respect to said tilt axis and said tilt axis extends through an area of said vertex, wherein said beam splitter is arranged at the outside of said vertex.

4. The mount device according to claim 1, wherein said mount element is hinged in a tilting manner at support means about said tilt axis.

5. The mount device according to claim 4, wherein said support means is supported in a tilting manner at said mounting means at a distance from said tilt axis.

6. The mount device according to claim 4, wherein said support means comprises two support elements arranged at the outside of both sides of said mount element.

7. The mount device according to claim 6, wherein said support elements are arc-shaped.

8. The mount device according to claim 7, wherein said support elements (9a, 9b) have an outward curvature.

9. The mount device according to claim 3, wherein said L-shaped mount element comprises two mount plates spaced at a distance from one another in the direction of said tilt axis.

10. The mount device according to claim 6, wherein said support elements are mirror-symmetric with respect to said vertical plane.

11. The mount device according to claims 6, wherein said support elements are detachably attached.

12. A stereoscopic recording device having a mount device the mount device comprising
a mount element which can be tilted at bearing means about a horizontal tilt axis;
a beam splitter attached to said mount element at a radial distance from said tilt axis and comprising a partially transparent mirror defining a mirror plane which extends in parallel to said tilt axis;
two attachment means mounted at said mount element at both sides of said beam splitter at an angular distance about said tilt axis, wherein one camera with a lens is mounted at each of said attachment means such that projections of optical axes of said lenses of said cameras seen from a horizontal direction intersect on an imaginary vertical plane intersected perpendicularly by said tilt axis and said optical axes impinge on said mirror plane;
wherein said tilt axis intersects with said imaginary vertical plane in an area limited by projections seen from a horizontal direction of said attachment means and said beam splitter on said vertical plane;
wherein mounting means are provided at said bearing means at a distance from said horizontal tilt axis for attachment to a pan and tilt fuild head.

13. The stereoscopic recording device according to claim 12, wherein said tilt axis is arranged such that it extends through an overall gravity center, projected in a horizontal projection on said vertical plane, of said cameras and said beam splitter and said mount element or in the proximity of said overall gravity center.

14. The stereoscopic recording device according to claim 12, wherein said mount element is substantially L-shaped with a vertex from which two legs extend perpendicularly with respect to one another, wherein said attachment means are mounted an said legs radially outside with respect to said tilt axis and said tilt axis extends through an area of said vertex, wherein said beam splitter is arranged at the outside of said vertex.

15. The stereoscopic recording device according to claim 12, wherein said mount element is hinged in a tilting manner at support means about said tilt axis.
